(19) United States
(12) Patent Application Publication
(10) Pub. No.: US 2026/0236592 A1
(43) Pub. Date: Aug. 13, 2026

(54) DATA PROTECTION SYSTEMS AND METHODS USING INTELLIGENT EXECUTABLE FILES

(71) Applicant: AT&T Intellectual Property I, L.P., Atlanta, GA (US)

(72) Inventors: Joseph Soryal, Glendale, NY (US); Christina Cacioppo, Freehold, NJ (US); Sherry L. McCaughan, Quinton, VA (US); Kenneth A. Duell, Princeton, NJ (US); Venson M. Shaw, Kirkland, WA (US)

(73) Assignee: AT&T Intellectual Property I, L.P., Atlanta, GA (US)

(21) Appl. No.: 19/050,282

(22) Filed: Feb. 11, 2025

(51) Int. Cl. G06F 21/60

(52) U.S. Cl. CPC G06F 21/602; G06F 21/6218

(57) ABSTRACT

Aspects of the subject disclosure may include, for example, systems and methods for enhanced data protection using intelligent executable files (IEFs). IEFs are deployed into data repositories or computing systems, where the IEFs are configured to self-install autonomously and monitor data activities, such as encryption, decryption, and data alterations. The IEFs are capable of blending in stored data and detecting unauthorized access attempts on the stored data and can trigger executable applications in response to the data activities. The IEFs communicate with a backend server for centralized management, sending notifications and logging events to ensure data integrity and security. Other embodiments are disclosed.

### FIELD OF THE DISCLOSURE

The subject disclosure relates to data protection systems and methods using intelligent executable files.

### BACKGROUND

Currently, it is unknown or unable to detect if data at rest was decrypted by an authorized entity and encrypted back again while a legitimate owner of data at rest is clueless to the fact that the data is compromised. If a malicious entity steals a decryption key for encrypted data at rest or encrypted traffic stream, the malicious entity can illegally decrypt the traffic or stored files, read the files, and then encrypt back. The legitimate owner may not have any idea that the encrypted traffic was exploded illegally and provides false sense of security. In other words, it may be difficult to ensure security/confidentiality beyond encryption.

Additionally, the malicious entity may attempt to perform data poisoning of training data to negatively impact the output of a large language model (LLM). It is desirable to detect improper decryption, ensure security/confidentiality beyond encryption, and implement data poisoning protection.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B is a block diagram illustrating another example, non-limiting embodiment of a system functioning within the communication network of FIG. 1 and including a generative artificial intelligence module in accordance with various aspects described herein.

FIG. 2C is a block diagram illustrating further another example, non-limiting embodiment of a system functioning within the communication network of FIG. 3 and including a third party cloud server in accordance with various aspects described herein.

FIG. 2D depicts an illustrative embodiment of a method in accordance with various aspects described herein.

FIG. 2E depicts an illustrative embodiment of another method in accordance with various aspects described herein.

FIG. 2F depicts an illustrative embodiment of further another method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for data protection systems and methods using intelligent executable files. Intelligent executable files (IEFs) are generated and deployed into a data repository environment, a computing system, a server, or used for training a data lake for use with a generative artificial intelligence such as a large language model. IEFs are configured to detect surrounding data types, data lengths, data locations, etc. on a disk, a memory storage, etc. IEFs are further configured to modify or recreate themselves to blend in other data pieces and potential malicious scan or improper or illegal data mapping may not detect or recognize IEFs. IEFs are connected to a backend server which sends and manage IEF instances. Upon an occurrence of predetermined events or conditions impacting at least a part of IEFs blended into other data pieces, IEFs are configured to send a notification to the backend server. Other embodiments are described in the subject disclosure.

One or more aspects of the subject disclosure are directed to a system, comprising a processing system including a processor; and a memory that stores executable instructions that, when executed by the processing system, facilitate performance of operations. The operations include deploying an intelligent executable file (IEF) into a data repository, wherein the IEF is configured to self-install in the data repository when deployed in the data repository; scanning, with the IEF, data stored in the data repository; detecting, with the IEF, surrounding data information including at least data types, data lengths, and data locations in the data repository, resulting in the IEF blended in the data stored in the data repository; detecting, using the blended IEF, an occurrence of decryption or encryption of at least a part of the data stored in the data repository; connecting the IEF to a backend server; and sending, using the IEF, the detected occurrence of decryption or encryption to the backend server include <Add in plain English key features of the invention>.

One or more aspects of the subject disclosure are directed to a non-transitory machine-readable medium, comprising executable instructions that, when executed by a processing system including a processor, facilitate performance of operations. The operations include facilitating a plurality of intelligent executable files (IEFs) to be installed into a computing system; triggering an executable application coded in an IEF upon an occurrence of a predetermined condition impacting the IEF, wherein the executable application coded in the IEF executes an action in response to the occurrence of the predetermined condition; connecting the plurality of IEFs to a backend server; and sending a notification to the backend server upon the occurrence of the predetermined condition impacting the IEF.

One or more aspects of the subject disclosure are directed to a method including generating, by a processing system including a processor, a first group of intelligent executable files (IEFs), wherein the first group of IEFs contains an executable application to be triggered upon an occurrence of a predetermined condition, respectively; transmit, by the processing system, the first group of IEFs into a server such that the first group of IEFs is self-installed therein, coincided with deployment of the first group of IEFs in the server; receiving a notification indicating the occurrence of the predetermined condition and the triggering of executable applications in one or more of the first group of IEFs that are impacted by the occurrence of the predetermined condition; and receiving, from the one or more of the first group of IEFs, information based on monitoring and updates following the occurrence of the predetermined condition.

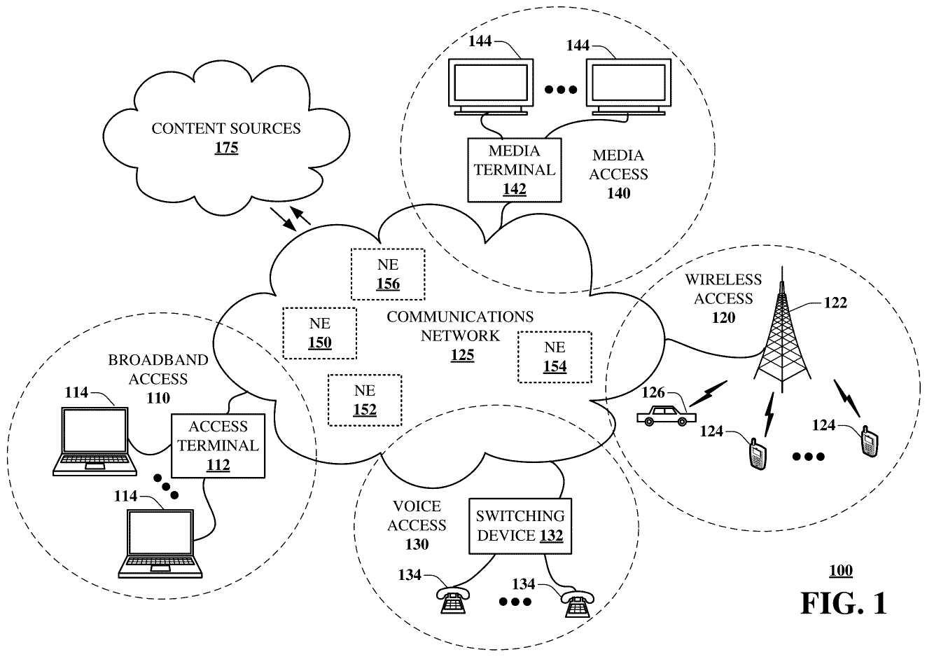

Referring now to FIG. 1, a block diagram is shown illustrating an example, non-limiting embodiment of a system 100 in accordance with various aspects described herein. For example, system 100 can facilitate in whole or in part encrypted data protection systems and methods using intelligent executable files (IEFs). In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

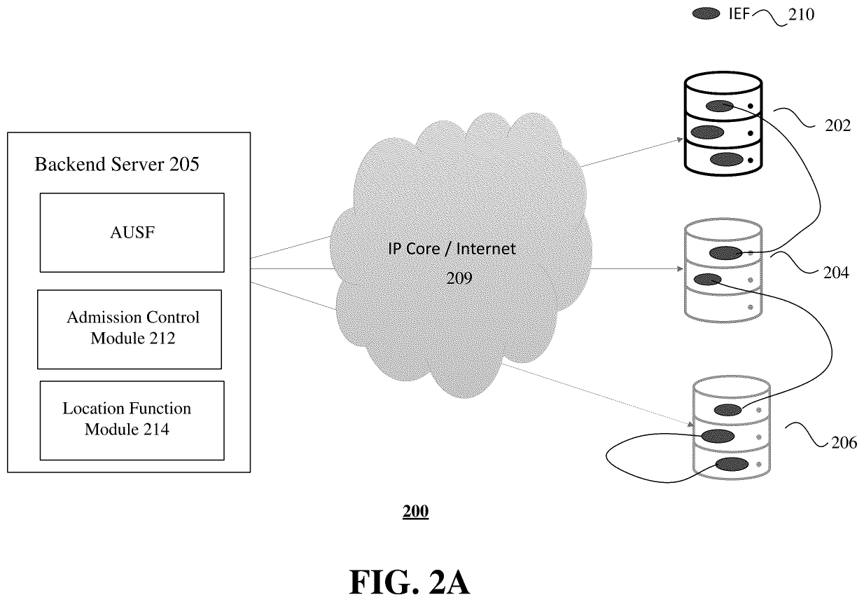

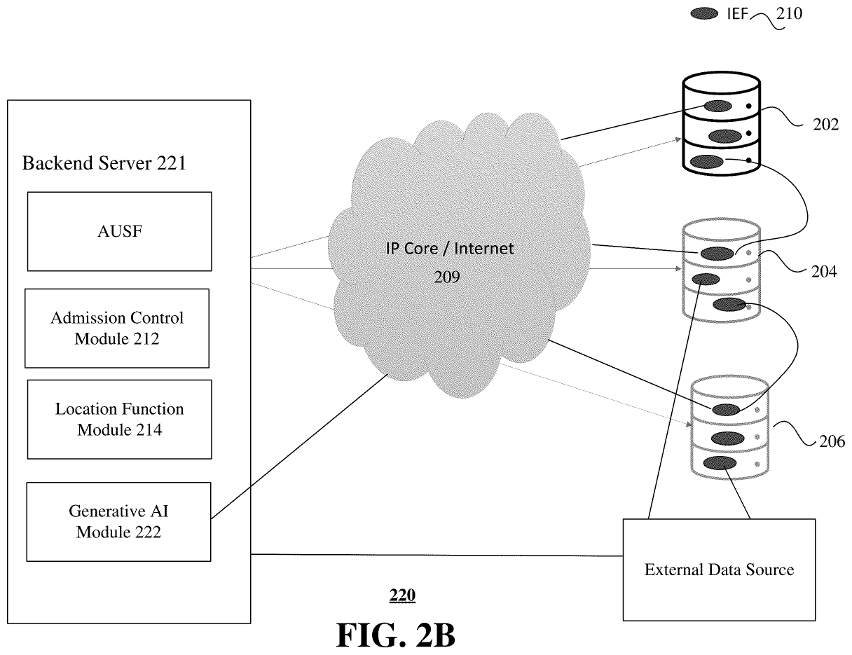

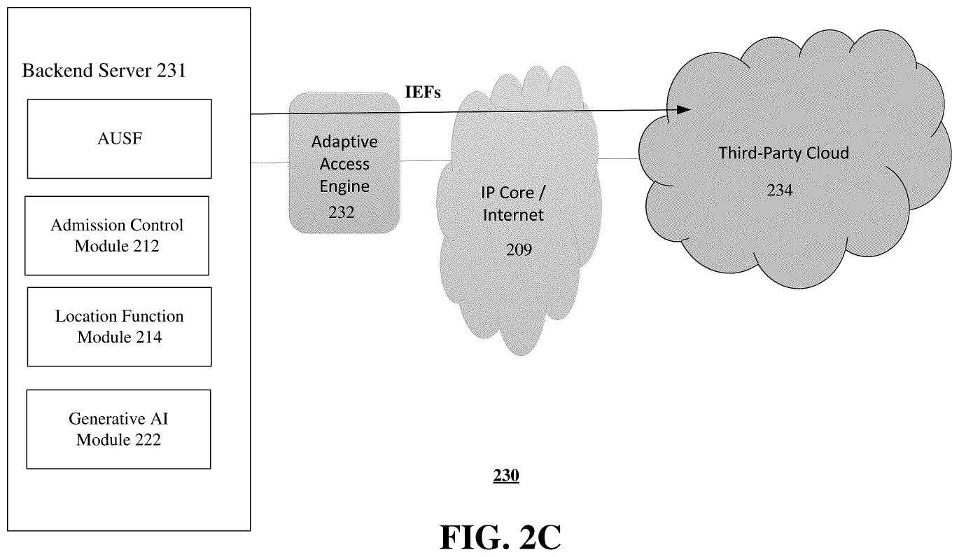

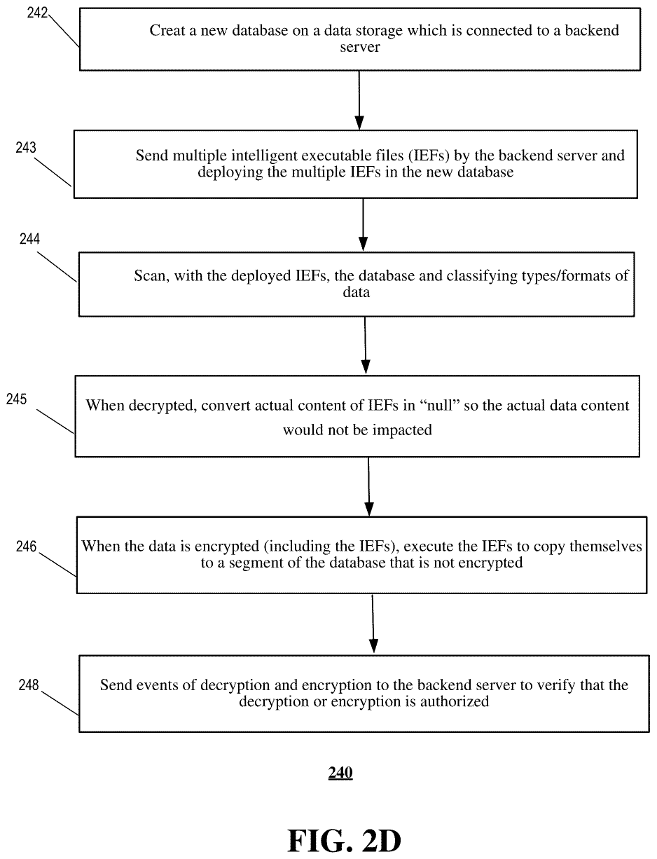

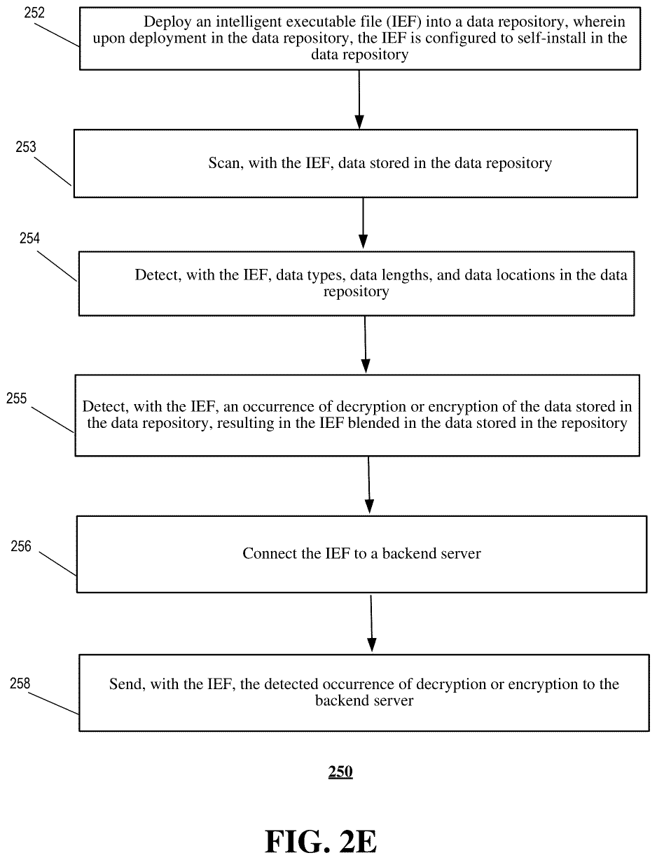

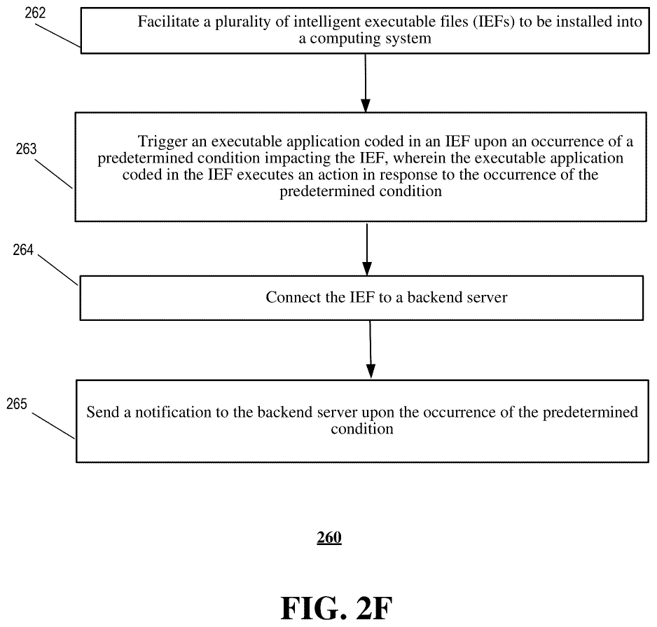

FIG. 2A is a block diagram illustrating an example, non-limiting embodiment of a system 200 functioning within the communication network of FIG. 1 in accordance with various aspects described herein. The system 200 includes a backend server 205 and a plurality of data repositories 202, 204, and 206. Each data repository includes multiple intelligent executable files (IEFs) 210. FIG. 2A depicts a few data repositories and several IEFs 210 for convenience of description and the present disclosure is not limited thereto. In some embodiments, the data repositories 202, 204, and 206 serve as data storages. Additionally or alternatively, the data repositories 202, 204, and 206 may be implemented with computing devices having computing power and storage space. In other embodiments, the data repositories 202, 204, and 206 may include a server. A server is a computer system or software application that provides services, resources, or data to other computers, known as clients, over a network. Servers are designed to manage, store, send, and process data seamlessly, enabling various functionalities such as hosting websites, managing emails, storing files, and running applications. Servers operate on a client-server model, where the server responds to requests from clients, facilitating communication and resource sharing across the internet. Servers can be dedicated hardware devices or virtualized instances running on shared hardware, and servers often run specialized software to handle specific tasks, such as web servers, database servers, or application servers.

In various embodiments, the system 200 utilizes intelligent executable files (IEFs) that are generated and deployed into a data repository environment or used for training a data lake. Upon deployment, the IEFs 210 can detect surrounding data types, lengths, locations, etc. on a disk, a memory storage, etc. Upon deployment, the IEFs 210 can modify or recreate themselves to blend in other data pieces and potential malicious scan or illegal data mapping may not detect or recognize the IEFs 210. The IEFs 210 may hide away from potential malicious scan or improper or illegal data mapping accordingly.

Generally, an executable file is a computer file that contains instructions for a computer's central processing unit (CPU) to run a program. When a user clicks on an executable file's icon, the computer runs the code contained in the file. Executable files contain binary machine code that has been compiled from source code. The CPU interprets the machine code and tells the computer's hardware what to do. Different operating systems have different executable file extensions. For example, the file extension for an executable file in Windows is .exe, while the file extensions for a MacOS application are .app or .ipa. Executable files can be vulnerable to malware, which can be used by bad actors to launch attacks. Most executable file formats include metadata that specifies behavioral runtime characteristics. This metadata can include the company that published a program, a date it was created, and a version number. In various embodiments of the present disclosure, IEFs depicted in FIG. 2A are equipped with various and different intelligent functions upon deployment into various computing environments.

In some embodiments, IEFs may be configured to attach themselves to host files or systems, such as executable files, boot sectors, or documents with macros. Trigger of IEFs can be based on specific conditions, such as predetermined data, a presence of certain files, an occurrence of certain events, etc., or, additionally or alternatively, the trigger may be performed by users or host systems such as the data repositories 202, 204, 206. IEFs are equipped with replication mechanism coded to allow IEFs to copy themselves and spread to other files or systems, such as inserting code of IEFs into other executable files or system areas, opening email attachments, etc. Upon activation, IEFs operate to attach to host files or executable files, spread, replicate, etc.

Referring back to FIG. 2A, the backend server 205 sends a plurality of IEFs 210 to be deployed in the data repositories 202, 204, 206. Upon deployment, the IEFs 210 are configured to self-install and proceed to scan the data repositories 202, 204 and 206 and classify types/formats of data. As one example, the IEFs 210 are configured to self-install immediately following the deployment. The installation of the IEFs 210 can be autonomous and instant, coincided with the deployment in the data repositories 202, 204 and 206. The installation of the IEFs 210 may not require a manual action by a user or any human intervention or involvement. Additionally or alternatively, the installation of IEFs 210 can be configured to be done at a predetermined time (e.g., passing a predetermined time period after the deployment). Further alternatively, the installation of IEFs 210 may be configured to require certain triggering actions such as a user's execution of a command or other activities (e.g., opening a file, a web link, etc.). After the installation, each IEF will morph into a piece of data that is similar to native data, in each data repository, to blend in. The IEFs 210 include an executable file, such as an application, and may perform various functions.

As depicted in FIG. 2A, IEFs 210 deployed in different data repositories 202, 204, 206 can communicate with one another and take coordinated actions across the data repositories 202, 204, 206. In some embodiments, the backend server 205 may send commands to and receive data from the data repositories once the IEFs 210 have been deployed therein. In other embodiments, the IEFs 210 deployed in the data repositories 202, 204, 206 can operate in a decentralized manner, using peer-to-peer networks to communicate. In that case, the data repositories 202, 204, 206 may form a client-server relationship, sharing information and instructions. Communications among the IEFs 210 may be performed using standard network protocols, subject to encryption, and/or use steganography to hide communication within innocuous data, such as images or videos, to avoid detection. Such communication capabilities allow the IEFs 210 to perform coordinated actions, update themselves, execute commands from a remote attacker, etc.

In various embodiments, trigger of the IEFs 210, deployed in the data repositories 202, 204, 206, may be initiated by changes to data stored in the data repositories 202, 204, 206, such as decryption, encryption, manipulation, modification, etc. As one example, when the data is encrypted (including the IEFs 210), the IEFs 210 will copy themselves to a segment of the data repositories 202, 204 and 206 that is not encrypted (e.g., OS protected space, log files, a special dedicated segment, etc.). The IEFs 210 will send the event of encryption to the backend server 205. As another example, when the data is decrypted, an IEF, as a small application, will send the backend server 205 this decryption transaction. The backend server 205 can verify with an administration if the decryption is authorized. The actual content of the IEFs 210, when decrypted, may show “null” so the IEFs 210 would not impact the actual data content. As the IEFs 210 include an executable file (e.g., a small application), the IEFs 210 can create themselves to be null.

In various embodiments, when an IEF is decrypted, an entire file gets converted to null, as described above, because the IEF is an intelligent executable software application that can be encrypted and stored. When the IEF gets decrypted, the file takes a decryption key and performs self-destruction to the package after it sends logs to the backend server 205 or one or more nearby unimpacted IEFs for the records and for a recreation of these decrypted IEFs if needed again.

In various embodiments, the IEFs 210 can move themselves on a memory segment in a storage (e.g., similarly to viruses), so the IEFs 210 are not mapped by a malicious entity such as hackers. Basically, the IEFs 210 are configured to behave autonomously as to where the IEFs 210 will deploy themselves next with the change of its binary structure to avoid detection by a malicious user. Each storage would have multiple IEFs 210 that are connected to the backend server 205 which sends these IEF instances and manage them.

As depicted in FIG. 2A, the IEFs 210 are connected to the backend server 205 which sends and manages IEF instances. The backend server 205 configures various IEF instances to include information about their proximity for potential collaboration regarding architecting various pieces of a host database structure (i.e., the data repositories 202, 204, 206). Whenever data are changed, such as encrypted/decrypted in each data repository 202, 204, 206, the IEFs 210 residing in each storage 202, 204 or 406 will send such event to the backend server 205. Also, when data is copied indiscriminately into another driver or is about to be shipped via a Network Interface Card (NIC), a notification such as an alarm can be generated. Also, an alarm will be triggered when volume of data under monitoring is configurable and being configured with new parameters.

In various embodiments, using the IEFs 210, monitoring against improper copying data can be performed. A copying of the IEF will trigger a replication of the executable file having a unique hash code. When the IEF 210 gets copied (a first copy still exists on a memory block unless new data is written over it by the Operating System), the IEF 210 has the ability to quietly scan the data repositories 202, 204, 206 to find other IEFs with the same unique hash code. In one or more embodiments, a unique hash code is utilized as a distinctive identifier for each intelligent executable file (IEF) deployed within each data repository 202, 204, 206. Additionally, when two or more IEFs merge, a new unique identifier may be generated. This hash code functions similarly to a digital fingerprint, allowing the IEF to maintain its identity across various operations and environments. When an IEF is copied or replicated, the unique hash code ensures that the original and its copies can be accurately tracked and identified. This capability is crucial for monitoring unauthorized data manipulation or replication, as it enables the system to detect and report any discrepancies or unauthorized changes to the data. The use of a unique hash code enhances the security and integrity of the data protection system 200 by providing a reliable mechanism for verifying the authenticity and consistency of IEF instances across different storage locations.

The IEFs 210 act as a distributed communicating elements on the data repositories 202, 204 and 206. As described above, IEFs 210 deployed in different data repositories 202, 204, 206 can communicate with one another and take coordinated actions across the data repositories 202, 204, 206. When one IEF finds its pairing IEF, both IEFs will scan the data repository they reside at and compare results and detect any data manipulation. The detected data manipulation will be reported to an administration for authorization validation. The system 200 is configured to getting any changes to data to be recorded and monitored as opposed to monitoring the data via external probing techniques and logging so the data changes are verified from within. External probing involves using tools or software to scan and analyze data from outside the system to detect unauthorized access or changes. External probing can be intelligent enough to change input and create combination of inputs and examine output. Inputs may come in a form of data query, moving data location, add a certain value (e.g., 2) to a data piece and check the result, etc.

External probing, however, may rely on periodic checks and can be limited by its inability to provide real-time monitoring or detect sophisticated attacks that evade external detection. Logging, on the other hand, involves recording events and activities within a system to create an audit trail. While logging can provide valuable insights into system operations and potential security breaches, it typically requires manual review and analysis to identify issues, which can be time-consuming and prone to oversight. Unlike external probing and logging, the system 200 operates, by embedding intelligent executable files (IEFs) within the data environment, such that these IEFs monitor data changes from within the system, providing a more proactive and integrated approach to data security. This internal monitoring allows for real-time detection of unauthorized decryption, data manipulation, or data poisoning, offering a more robust and efficient solution compared to external probing techniques and logging.

In various embodiments, the backend server 205 includes an admission control module 212. The backend server 205 performs admission control where an authentication element requires knowledge of how many data fragments have been decrypted and encrypted back, copied, modified, manipulated, etc. The backend server 205 implements virtual network functions, particularly including Authentication Server Function (AUSF). AUSF (Authentication Server Function) is one of components of the 5G network architecture. AUSF is responsible for verifying the identity of a subscriber, validating their subscription data, and determining the appropriate security context for the subscriber. One of the primary functions of AUSF is to support 5G authentication and authorization procedures. When a subscriber attempts to connect to the 5G network, the AUSF plays a key role in verifying their identity and ensuring that they have the proper authorization to access the network. AUSF interacts with several other network functions to provide a seamless and secure experience for 5G subscribers. For example, AUSF communicates with Access and Mobility Management Function (AMF) to manage subscriber mobility and handover procedures. AUSF also interacts with the Unified Data Management (UDM) function to manage subscriber data and profiles. AUSF is designed to be scalable and flexible, allowing it to support a wide range of 5G use cases and applications. It is also designed to provide robust security features, including encryption and authentication mechanisms, to protect against unauthorized access and data breaches.

In one or more embodiments, database segments stored in the data repositories 202, 204, 206 require credentials (e.g., username and password) to access. In some embodiments, times that data was encrypted/decrypted can be added as a parameter, monitored by using the IEFs 210, and reported to the backend server 205. The backend server 205 may store such parameter in an admission control module 212. An authorized user queries the backend server 205 having the admission control module 212 first for a number of encryption/decryption on a particular data segment via an automated user interface. For instance, the authorized user is authorized to access and make changes to the particular data segment. The authorized user would log into a database containing the particular data segment with regular credentials plus values obtained from the backend server 205 (e.g., a number of encryption/decryption) and upon logging in, the values such as the number of encryption/decryption should match for database access. The backend server 205 can perform admission control to the particular data segment accordingly.

In various embodiments, the backend server 205 further includes a location function module 214 which tracks data throughout databases. The databases can be internal and external databases. In the backend server 205, the location function module 214 functions similar to domain name service (DNS) in terms of tracking the IEF instances across mapped databases. The mapping of databases (internal and external) are entered into this location function module 214. Each created and released IEF instance would have a record that will also be entered at the location function module 214. When the IEF 210 goes into a target database, it will communicate back with the location function module 214 for record updates (or it can entered manually). These records are useful to quickly check the database status and what are the processes that the database is encountering, as will be further described in connection with FIG. 2C below.

FIG. 2B is a block diagram illustrating another example, non-limiting embodiment of a system 220 functioning within the communication network of FIG. 1 and including a generative artificial intelligence (Gen-AI) module in accordance with various aspects described herein. The system 220 includes a backend server 221, coupled to computing systems or servers 202, 204 and 206, via the internet 209. The backend server 221 includes an AUSF module, the admission control module 212 and the location function module 214 as described above in connection with FIG. 2A. The backend server 221 further includes the Gen-AI module 222 implementing a large language model (LLM).

As described above in connection with FIG. 2A, the IEF 210 is an executable file that get transported between the data repositories 202, 204 and 206, computing devices, servers, etc. Once the IEF 210 reaches the destination, the IEF 210 installs itself and becomes an application. Additionally, this application can have many modules, including a library of databases, a generative AI element, etc. As one example, the generative AI element is configured to generate fake entries to blend in. Fake entries that resemble the actual data reside in the database. For example, if the existing data is driver licenses numbers, then the generative AI element hide its application in a fake entry that looks like driver license number. As another example, the application also has an LLM model that is installed inside the database (or a computer in general) and understands the data stored on this device in terms of structure, data type, sensitivity, privacy, the location of the device, etc.

In various embodiments, the LLM model can be designed to interact with the database and understand the data stored within the database by employing a combination of techniques and tools. The LLM model can be integrated with database connectivity tools or application program interfaces (APIs) that allow the LLM model to access the database. This involves establishing a secure connection to the database using appropriate credentials and permissions. Once connected, the LLM can query the database schema to understand the structure of the database. This includes identifying tables, columns, data types, relationships, and constraints. By analyzing the schema, the LLM model can gain insights into how data is organized and related. The LLM can perform data profiling to gather statistics and metadata about the data stored in the database. This includes understanding data types, distributions, patterns, and anomalies. Data profiling helps the LLM model to comprehend the nature and characteristics of the data. The LLM model can apply natural language processing techniques to interpret any textual data within the database. This involves analyzing text fields to extract meaning, context, and sentiment, which can provide additional insights into content and purpose of the data.

In various embodiments, when the LLM model understands the data stored in the database, the LLM model generates an output that can take various forms. For instance, the LLM model can generate a comprehensive summary of the database, highlighting key aspects such as the number of tables, types of data stored, relationships between data entities, and any notable patterns or anomalies. The LLM model can produce detailed documentation of the database schema, including descriptions of tables, columns, data types, and constraints. The LLM model can highlight unusual patterns or anomalies in the data that may require further investigation, such as potential security breaches or data integrity issues. The LLM model can create visual representations of the data, such as charts, graphs, or dashboards, to facilitate easier interpretation and analysis by users.

In various embodiments, as described above, multiple IEFs communicate and share knowledge and may generate a recommendation to the system administration (via the backend server 221) in terms of separating elements of the data repositories 202, 204 and 206 or merging, or hiding, etc. The LLM model inside the IEF may interact with the Gen-AI module 222 in the backend server 205 that has global knowledge to share information and coordinate.

In some embodiments, the Gen-AI module 222 may generate IEF instances. Variable software packages (IEFs) can be created with the generative AI module 222. The backend server 221 functions as a generator of IEF instances based use cases and target data structure and internal data manipulation routines. The backend server 221 includes the GenAI module 222 as an embedded element that has two interfaces for learning. One of the two interfaces includes an external interface for public knowledge regarding access mechanisms and data structures. The other interface includes an internal interface as to the specific company data and methods of data treatments pertaining to a project/a company—so this interface is internal and specific to the project/the company. The internal interface is intimately familiar with data structure and privacy/security needs and controls of the company. The Gen-AI module 222 can be added to an existing LLM operating within the company or available in the relevant art. This specialized LLM model may look for databases in the companies repositories and also look into policy and guidelines of the company on how to protect this data access and retention policies. A main purpose is to have the Gen-AI module 222 such as a specialized LLM model familiar with all data structure types and contents for the company. When it is time to generate an IEF, the Gen-AI module 222 can generate specialized data structure for the IEF and based on the security/privacy policies, the Gen-AI module 222 can include warning triggers inside the IEF which will be unique to each database type.

In various embodiments, the IEFs 210 may be configured to prevent data poisoning in data lake for training a large language model (LLM). As one example of data poisoning for use, the LLM can be trained, by a malicious actor, on a wrong set of data, thereby resulting in an incorrect outcome intentionally. When the LLM is trained on the wrong data set, an output from the LLM may be incorrect or intended to contain a negative bias. For instance, the LLM can be trained to generate an output based on a biased profile, a biased classification, a biased standard, a biased stereotype, etc. As another example, the LLM can be trained to generate a bias promoting a business need such as outputting information about cancer medication with high risk as a good option. As further another example, the LLM can be trained to generate an incorrect output for political reasons, religions regions, historical reasons, outstanding war or diplomatic disputes, etc. The negative bias may be implemented to target a specific group of users or businesses to misguide them. In some embodiments, such incorrect outcome or negative bias may be generated by altering or changing relevant data values to impact the outcome.

In some embodiments, the IEFs 210 are applicable to data lakes used to feed machine learning algorithms and LLM. For example, the IEF instances can scan the data lake and morphs itself into the same format/shape and blend in. For the data lakes, there shall be many IEF instances and if a malicious user tries to alter the values illegally or improperly, they will most likely change one of the IEF instances which can be reported back to the backend server 221 for auditing and investigating.

In other embodiments, on the other hand, the LLM can be trained to generate a result promoting a positive bias. For instance, the LLM is trained to generate a result including encouragement, advice, suicide prevention messages, medical treatment options, etc. The LLM is trained to reflect locations of users (geographical locations, certain countries having certain political systems, etc.), a personal profile, a medical history, etc. Accordingly, the LLM operates based on customization, personalization, etc. As one example, the LLM may operate as a doctor's prescription in addition to a physical prescription as doctors promote a positive bias toward certain medications via the LLM. The LLM may be trained to generate a result reflecting professional advice, caution, etc. in various fields. To facilitate promoting a positive bias, the IEF instances can scan the data lake and morphs itself into the same format/shape and blend in. Then the IEF instances may try to change values relevant to the positive bias, along with other IEF instances included in the training data like. The backend server 221 generates IEF instances to be programmed to change values as intended upon deployment and installed in the training data lake. The change of values will be reported back to the backend server 221 and subject to monitoring in order to check that results may incorporate or promote a positive bias.

FIG. 2C is a block diagram illustrating further another example, non-limiting embodiment of a system 230 including a third party cloud server in accordance with various aspects described herein. The system 230 is configured to deploy IEFs in a database, a data repository, a computing system, a server, etc. on a third-party cloud 234. The system 230 further includes an interface 232 which is equipped with the credentials and access mechanisms to access and control the data stored on the third-party cloud 234. The interface is referred to as an adaptive access engine (AAE) 232, as shown in FIG. 2C. The AAE 232 will have a library to learn how to access each cloud in terms of credentials, format of access requests/responds, etc.

As depicted in FIG. 2C, IEFs will be sent via the access tunneled via the AAE 232. The AAE 232 understands how each third-party cloud behaves and will study the contents of the IEFs back and forth. Detecting hidden processes on data at the third-party cloud operates as follows. Some data sent to the third party clouds are subject to unknown processes. The IEFs here would be a monitor from within to record any processes taken by the third-party cloud to treat the data. For instance, the processes taken by the third-party cloud may include encryption/decryption, packaging, padding, compression, duplications, sent to offshore platform, etc. The records of events are either stored, encrypted on the IEFs until the IEF gets sent/invoked home or the IEF can be configured to send these updates to the backend server 231 that functions as a repository of events. Records can be reviewed by automated systems or personnel to ensure that the data is treated off premises with the same rules intended.

In various embodiments, the AAE 232 may reformat the IEF to give new credentials. The AAE 232 may be equipped with capabilities to learn from the Internet and the manuals and catalogs from that third party, etc., and adapt to make the IEF look like a legitimate database piece into the third party cloud 234. If the third party cloud 234 has firewalls to prevent executable files, so the AAE 232 may reassemble the IEF as a flat file, for example. In some embodiments, the AAE 232 can be potentially used with data under control of a cloud service provider. In one or more embodiments, the adaptive access engine can be a 6G new function as being not covered by 5G functions. The backbone network operates as a domain name server (DNS), looking up to the different directories to a different level of securities, each of directories can further manage the IEFs.

In various embodiments, the AAE 232 can modify and change IEFs according to location, users and so forth. The AAE 232 can also be used to protect any data, such as Internet, social medias cloud, public cloud, private cloud, enterprise data, etc. The AAE 232 can be used to protect any storage, such as a solid SSD, a personal computer used for a public cloud, a thirty party cloud, data lake, etc. The AAE 232 can be used with a solid state device (SSD) readily available, any data inside the SSD or a conventional computer, etc. The AAE 232 can be installed at a house, at a car (connected cars) to protect entire home/car network data. Adaptive access engines can communicate with one another. Adaptive access engines can trigger the alarm on its own such as a disaster recovery outage.

FIG. 2D depicts an illustrative embodiment of a method 240 in accordance with various aspects described herein. In various embodiments, the method 240 includes creating a new database on a data storage which is connected to a backend server (Step 242). The method 240 further includes sending multiple IEFs by the backend server and deploying the multiple IEFs in the new database (Step 243). The method 240 includes scanning, with the deployed IEFs, the database and classifying types/formats of data (Step 244). Each IEF will morph into a piece of data that is similar to the native data to blend in.

The method 240 includes, when decrypted, converting actual content of IEFs in “null” so the actual data content would not be impacted (Step 245). This is because the IEFs are executable files (e.g., a small application) and IEFs can create themselves to be null. The method 240 also includes, when the data is encrypted (including the IEFs), executing the IEFs to copy themselves to a segment of the database that is not encrypted (e.g., OS protected space, log files, a special dedicated segment, . . . etc.) (Step 246). The method 240 includes sending events of decryption and encryption to the backend server to verify that the decryption or encryption is authorized (Step 248). When the data is decrypted, the IEFs, as a small application, send the backend server the events of decryption or encryption in order for the backend server to verify with an administration if the decryption or encryption is authorized.

FIG. 2E depicts an illustrative embodiment of a method 250 in accordance with various aspects described herein. The method 250 depicted in FIG. 2E includes deploying an intelligent executable file (IEF) into a data repository, where upon deployment in the data repository, the IEF is configured to self-install in the data repository (Step 252). As one example, the installation of the IEF can be autonomous and instant, following the deployment in the data repository. The installation of the IEF may not require a manual action or any form of human involvement. Alternatively, the installation of the IEF can be configured to be done upon a certain triggering event, a human action, etc. Further alternatively, the installation of the IEF may be configured to be set at a certain time after the deployment. The IEF becomes embedded and an integral part of the data environment, allowing it to operate seamlessly within the existing data infrastructure. The method 250 further includes scanning, with the IEF, data stored in the data repository (Step 253). During this step, the IEF actively examines the data to gather information about its structure and content, enabling it to monitor changes effectively.

The method 250 also includes detecting, with the IEF, data types, data lengths, and data locations in the data repository, resulting in the IEF blended in the data stored in the data repository (Step 254). This detection process allows the IEF to understand the nature of the data it is monitoring, which is crucial for identifying any unauthorized access or modifications. The method 250 involves detecting, with the IEF, an occurrence of decryption or encryption of the data stored in the data repository (Step 255). By monitoring encryption and decryption events, the IEF can identify potential security breaches or unauthorized data access attempts. The method 250 includes connecting the IEF to a backend server (Step 256). This connection facilitates centralized control and coordination of multiple IEF instances, allowing for efficient management and response to detected events. The method 250 involves sending, with the IEF, the detected occurrence of decryption or encryption to the backend server (Step 258). This step ensures that all relevant events are logged and can be reviewed by administrators or automated systems to verify the legitimacy of encryption and decryption events and maintain data security.

FIG. 2F depicts an illustrative embodiment of another method 260 in accordance with various aspects described herein. The method 260 depicted in FIG. 2F includes facilitating a plurality of intelligent executable files (IEFs) to be installed into a computing system (Step 262). This step ensures that the IEF integrates seamlessly into the system, allowing it to function autonomously within the existing infrastructure. The method 260 further includes triggering an executable application coded in the IEF upon an occurrence of a predetermined condition impacting the IEF, where the executable application coded in the IEF executes an action in response to the occurrence of the predetermined condition (Step 263). This capability allows the IEF to respond dynamically to specific events, such as unauthorized access attempts or data modifications.

The method 260 also includes connecting the IEF to a backend server (Step 264). This connection enables the IEF to communicate with the backend server, facilitating centralized management and coordination of multiple IEF instances. The method 260 involves sending a notification to the backend server upon the occurrence of the predetermined condition (Step 265). This step ensures that significant events are logged and can be reviewed by administrators or automated systems to verify their legitimacy and maintain system security.

In various embodiments, the occurrence of the predetermined condition further comprises manipulation or change to the data stored in the computing system, including the IEF, and the method 260 further includes sending the backend server the notification notifying the data manipulation or the data change. The occurrence of the predetermined condition further comprises manipulation or change to the data stored in the computing system impacting the blended IEFs. The method 260 further includes identifying one or more IEFs that are not impacted by the occurrence of the predetermined condition and share an identifier with the impacted blended IEFs.

The occurrence of the predetermined condition further comprises altering one or more values of the data stored in the computing system, and the method 260 further includes sending the backend server the notification notifying the altered one or more values of the data stored in the computing system. The occurrence of the predetermined condition further comprises decryption or encryption of the data stored in the computing system, and the method 260 further comprise performing admission control by allowing a user to check a record of decryption or a record of encryption with respect to selected data. The record of decryption or the record of encryption are stored in the backend server.

In various embodiments, the method 260 further includes sending multiple intelligent executable file (IEFs) to a third party cloud via an adaptive access engine (AAE). The AAE includes a library including access information to the third party cloud in terms of credentials, a format of access requests, and a format of access respond. The method 260 also includes deploying the multiple IEFs in a host system running on the third party cloud. The method 260 further includes monitoring, with the multiple IEFs deployed in the host system, one or more processes taken by the third party cloud to handle data stored in the host system, and generating a record of the one or more processes, thereby sending the record to the backend server. The record is subject to an inspection to ensure that the data off premises have been treated based on a same set of rules applicable to data on premises.

In various embodiments, IEFs deployed in the data repository, the computer system, the server, etc. include a sufficient number of IEFs to ensure that malicious data scan or improper or illegal data manipulation can be detected by impacted IEFs. For instance, data manipulation includes encryption, decryption, packing, padding, compression, duplications, transmission to an offshore platform, or a combination thereof.

While for purposes of simplicity of explanation, the respective processes are shown and described as a series of blocks in FIGS. 2D through 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

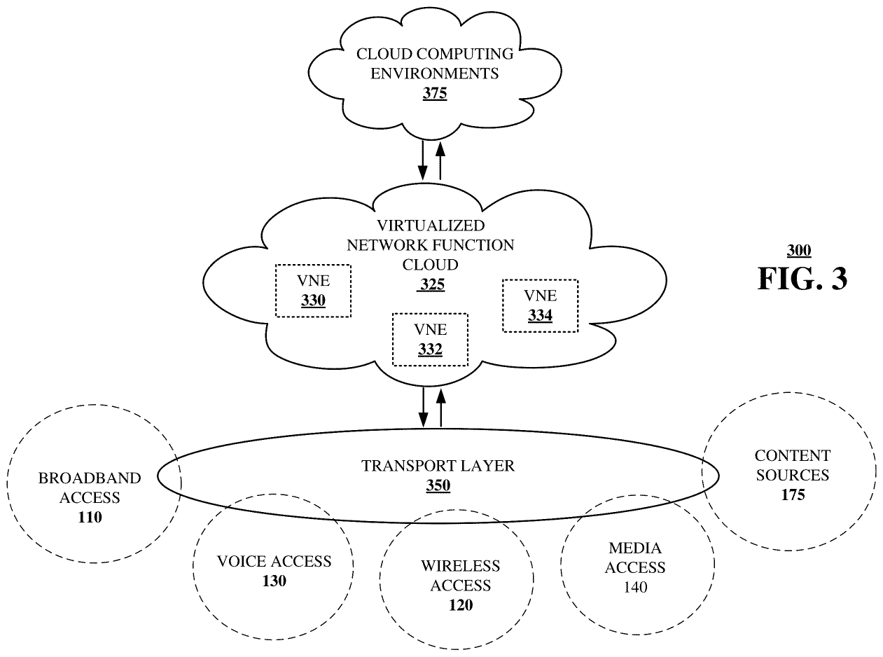

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of system 100, the subsystems and functions of system 200, and method 230 presented in FIGS. 1, 2A, 2B, 2C, and 3. For example, virtualized communication network 300 can facilitate in whole or in part encrypted data protection systems and methods using intelligent executable files.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

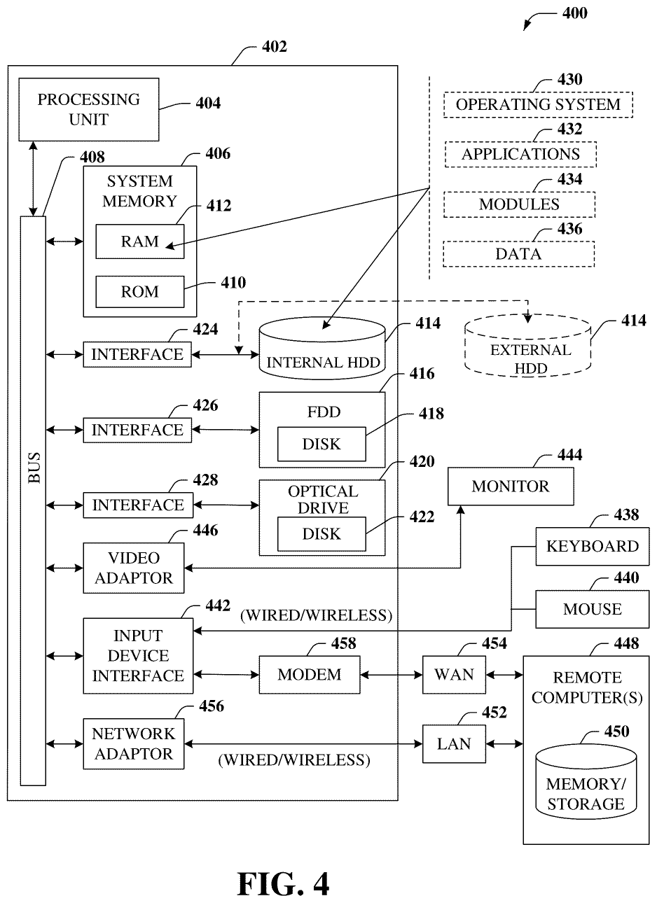

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part encrypted data protection systems and methods using intelligent executable files.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

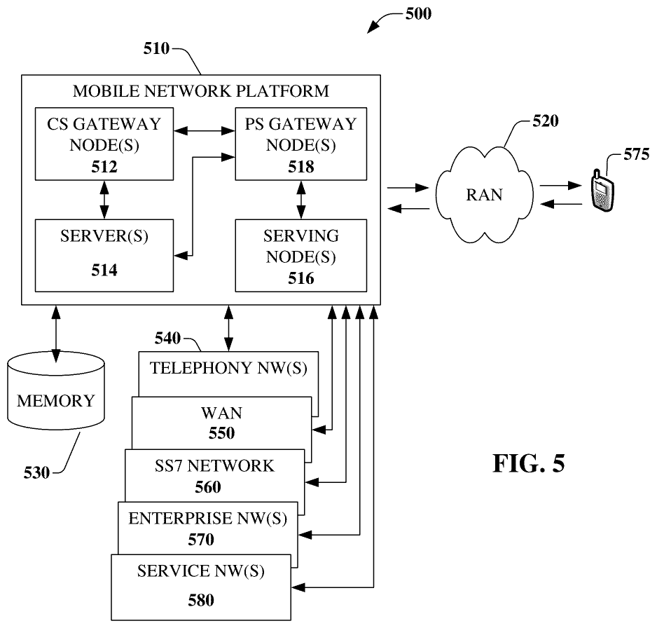

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part encrypted data protection systems and methods using intelligent executable files. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

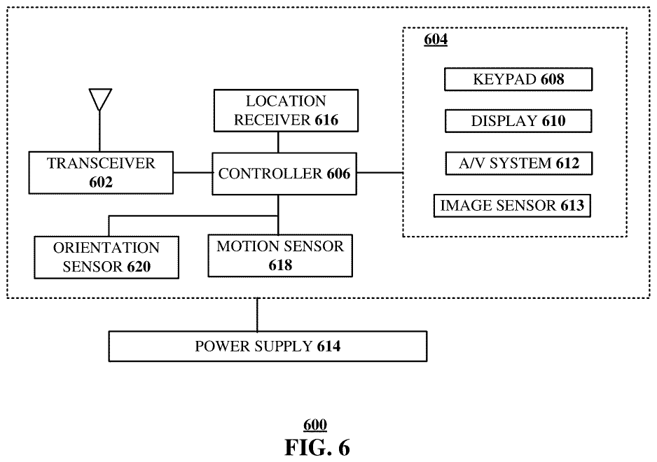

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part encrypted data protection systems and methods using intelligent executable files.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, X=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

1. A system, comprising:
a processing system including a processor; and
a memory that stores executable instructions that, when executed by the processing system, facilitate performance of operations, the operations comprising:
deploying an intelligent executable file (IEF) into a data repository, wherein the IEF is configured to self-install in the data repository when deployed in the data repository;
scanning, with the IEF, data stored in the data repository;
detecting, with the IEF, surrounding data information including at least data types, data lengths, and data locations in the data repository, resulting in the IEF blended in the data stored in the data repository;
detecting, using the blended IEF, an occurrence of decryption or encryption of at least a part of the data stored in the data repository;
connecting the IEF to a backend server; and
sending, using the IEF, the detected occurrence of decryption or encryption to the backend server.

2. The system of claim 1, wherein the operations further comprise:
upon the detecting of the occurrence of encryption of the IEF, facilitating the IEF to be copied to a segment of the data repository that is not encrypted; and
upon the detecting of the occurrence of decryption of the IEF, facilitating the IEF to convert content of the IEF to be null.

3. The system of claim 1, wherein the operations further comprise:
facilitating the IEF to recreate itself to blend in with data pieces stored in the data repository based on the detected surrounding data information in order to avoid detection by a malicious scans or improper or illegal data mapping.

4. The system of claim 1, wherein the operations further comprise:
generating, using the IEF, alarms when the data stored in the data repository is copied indiscriminately or about to be transmitted via a network interface card (NIC).

5. The system of claim 1, wherein the operations further comprise:
performing admission control to access a selected data fragment in the data repository by requiring to present a predetermined parameter, wherein the predetermined parameter includes a number of times that the selected data fragment has been decrypted, encrypted back, copied, or modified.

6. The system of claim 1, wherein the operations further comprise establishing a communication between the IEF and a generative artificial intelligence (Gen-AI) module residing in the backend server.

7. The system of claim 1, wherein the deploying further comprises deploying the IEF into a data lake for training a large language model, wherein the IEF is configured to detect alteration of data content therein.

8. The system of claim 1, wherein the deploying further comprises deploying the IEF in the data repository residing in a third party cloud via an adaptive access engine.

9. The system of claim 8, wherein the adaptive access engine comprises a library including access information to the third party cloud with respect to access credentials and a format of access requests and responses.

10-20. (canceled)

21. A non-transitory machine-readable medium, comprising executable instructions that, when executed by a processing system including a processor, facilitate performance of operations, the operations comprising:
deploying an intelligent executable file (IEF) into a data repository, wherein the IEF is configured to self-install in the data repository when deployed in the data repository;
scanning, with the IEF, data stored in the data repository;
detecting, with the IEF, surrounding data information including at least data types, data lengths, and data locations in the data repository, resulting in the IEF blended in the data stored in the data repository;
detecting, using the blended IEF, an occurrence of decryption or encryption of at least a part of the data stored in the data repository;
connecting the IEF to a backend server; and sending, using the IEF, the detected occurrence of decryption or encryption to the backend server.

22. The non-transitory machine-readable medium of claim 21, wherein the operations further comprise:
upon the detecting of the occurrence of encryption of the IEF, facilitating the IEF to be copied to a segment of the data repository that is not encrypted; and
upon the detecting of the occurrence of decryption of the IEF, facilitating the IEF to convert content of the IEF to be null.

23. The non-transitory machine-readable medium of claim 21, wherein the operations further comprise:
facilitating the IEF to recreate itself to blend in with data pieces stored in the data repository based on the detected surrounding data information in order to avoid detection by malicious scans or improper or illegal data mapping.

24. The non-transitory machine-readable medium of claim 21, wherein the operations further comprise:
generating, using the IEF, alarms when the data stored in the data repository is copied indiscriminately or about to be transmitted via a network interface card (NIC).

25. The non-transitory machine-readable medium of claim 21, wherein the operations further comprise:
performing admission control to access a selected data fragment in the data repository by requiring to present a predetermined parameter, wherein the predetermined parameter includes a number of times that the selected data fragment has been decrypted, encrypted back, copied, or modified.

26. The non-transitory machine-readable medium of claim 21, wherein the operations further comprise establishing a communication between the IEF and a generative artificial intelligence (Gen-AI) module residing in the backend server.

27. A method, comprising:
deploying, by a processing system including a processor, an intelligent executable file (IEF) into a data repository, wherein the IEF is configured to self-install in the data repository when deployed in the data repository;
scanning, by the processing system with the IEF, data stored in the data repository;
detecting, by the processing system with the IEF, surrounding data information including at least data types, data lengths, and data locations in the data repository, resulting in the IEF blended in the data stored in the data repository;
detecting, by the processing system using the blended IEF, an occurrence of decryption or encryption of at least a part of the data stored in the data repository;
connecting, by the processing system, the IEF to a backend server; and
sending, by the processing system using the IEF, the detected occurrence of decryption or encryption to the backend server.

28. The method of claim 27, further comprising:
upon the detecting of the occurrence of encryption of the IEF, copying, by the processing system, the IEF to a segment of the data repository that is not encrypted; and
upon the detecting of the occurrence of decryption of the IEF, converting, by the processing system, content of the IEF to be null.

29. The method of claim 27, wherein deploying the IEF further comprises deploying the IEF into a data lake for training a large language model, and wherein the IEF is configured to detect alteration of data content in the data lake.

30. The method of claim 27, wherein deploying the IEF further comprises deploying the IEF in the data repository residing in a third party cloud via an adaptive access engine.

31. The method of claim 30, wherein the adaptive access engine comprises a library including access information to the third party cloud with respect to access credentials and a format of access requests and responses.
